(19) United States
(12) Patent Application Publication
(10) Pub. No.: US 2008/0242379 A1
(43) Pub. Date: Oct. 2, 2008

(54) COMMUNICATION TERMINAL

(75) Inventor: Katsushige FUJII, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/055,853

(22) Filed: Mar. 26, 2008

(30) Foreign Application Priority Data
Mar. 27, 2007 (JP) 2007-080564

(51) Int. Cl. H04M 1/00

(52) U.S. Cl. 455/575.3

(57) ABSTRACT

A communication terminal includes a first case and a second case. The first case and the second case are connected by a connector such that a position of the first case with respect to the second case is changeable. An antenna is provided to one main surface of the first case, and a first display is provided so as to be exposed at a specific position where the one main surface of the first case is covered with one main surface of the second case, at the other main surface of the first case or the other main surface of the second case. A first outputter outputs a first notification that a communication by the antenna is in a bad condition in correspondence with the specific position from the first display.

### CROSS REFERENCE OF RELATED APPLICATION

The disclosure of Japanese Patent Application No. 2007-80564 is incorporated herein by reference.

### BACKGROUND OF THE INVENTION

1. Field of the Invention

The present invention relates to a communication terminal. More specifically, the present invention relates to a communication terminal which performs a communication by utilizing an antenna for short distance radio communication.

2. Description of the Related Art

According to a related art, a first housing and a second housing are connected with a hinge. An outer surface of the first housing is provided with a main antenna for performing a short distance radio communication with a reader/writer and a plurality of antennas for measuring to measure a receiving condition of radio from the reader/writer. Furthermore, an inner surface of the second housing is provided with a display device. When a direction in which the reader/writer exists is detected by the antennas for measuring, an arrow indicating the detected direction is displayed on the display device. Thus, it is possible to make a good communication with the reader/writer.

In the related art, the antenna is provided on the outer surface of the first housing, and therefore, the antenna is never covered with the second housing due to structural characteristics of the hinge. However, depending on the structure of the hinge, the antenna is covered with the second housing to thereby make a short distance radio communication impossible. That is, depending on the structure of the hinge, operability may be decreased.

### SUMMARY OF THE INVENTION

In one aspect of the present invention, a communication terminal, comprises: a first case and a second case; a connector for connecting the first case and the second case such that a position of the first case with respect to the second case is changeable; an antenna provided to one main surface of the first case; a first display provided so as to be exposed at a specific position where the one main surface of the first case is covered with one main surface of the second case, at the other main surface of the first case or the other main surface of the second case; and a first outputter for outputting a first notification that a communication by the antenna is in a bad condition from the first display in correspondence with the specific position.

A connector connects a first case and a second case such that a position of the first case with respect to the second case is changeable. An antenna is provided to one main surface of the first case. A first display is provided so as to be exposed at a specific position where the one main surface of the first case is covered with one main surface of the second case, at the other main surface of the first case or the other main surface of the second case. A first outputter outputs a first notification that a communication by the antenna is in a bad condition from the first display in correspondence with the specific position.

Since the antenna is provided to the one main surface of the first case, receiving sensitivity of the antenna is decreased at a specific position where the one main surface of the first case is covered with the one main surface of the second case. On the other hand, the first display is provided to the other main surface of the first case or the other main surface of the second case so as to be exposed at such a specific position. Hence, in the present invention, the first notification that a communication by the antenna is in a bad condition is output from the first display in correspondence with the specific position.

The features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a configuration of a first embodiment of the present invention;

FIG. 2(A) is a perspective view showing an appearance of the first embodiment having a certain position;

FIG. 2(B) is a perspective view showing an appearance of the first embodiment having another position;

FIG. 3(A) is a perspective view showing an appearance of the first embodiment having a still another position;

FIG. 3(B) is a perspective view showing an appearance of the first embodiment having a further position;

FIG. 4 is a flowchart showing a part of an operation of the CPU applied to the first embodiment;

FIG. 5 is a perspective view showing an appearance of a second embodiment having a certain position;

FIG. 6(A) is a perspective view showing an appearance of the second embodiment having another position;

FIG. 6(B) is a perspective view showing an appearance of the second embodiment having a still another position;

FIG. 7(A) is a perspective view showing an appearance of a third embodiment having a certain position;

FIG. 7(B) is a perspective view showing an appearance of the third embodiment having another position;

FIG. 7(C) is a perspective view showing an appearance of the third embodiment having a still another position; and

FIG. 8 is a flowchart showing a part of a modified example of the operation of the CPU applied to the first embodiment.

### DETAILED DESCRIPTION OF THE PREFERRED EMBODIMENTS

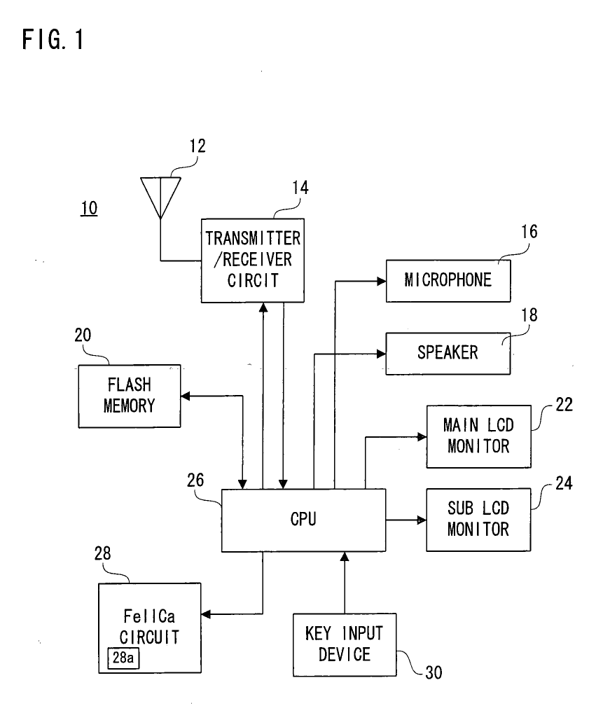

Referring to FIG. 1, a mobile communication terminal 10 of this embodiment includes a key input device 30. When a call-out operation is performed by the key input device 30, a CPU 26 outputs a call-out signal by controlling a transmitter/receiver circuit 14 in correspondence with a CDMA system. The output call-out signal is emitted from an antenna 12 and transmitted to a telephone of an intended party through a mobile communication network including a base station. When the intended party performs a call-in operation, a telephone communication allowable state is established.

After the shift to the telephone communication allowable state, when a conversation end operation is performed by the key input device 30, the CPU 26 sends a conversation end signal to the intended party by controlling the transmitter/receiver circuit 14. After completion of the transmission of the conversation end signal, the CPU 26 ends the conversation processing. Also, in a case that a conversation end signal from the intended party is first received, the CPU 26 ends the telephone communication processing. Furthermore, in a case that a conversation end signal is received from the mobile communication network not by the intended party, the CPU 26 ends the telephone communication processing.

When a call-out signal from the intended party is received by the antenna 12 in a state that the entire system is activated, the transmitter/receiver 14 notifies an incoming call to the CPU 26. The CPU 26 outputs calling source information described in the incoming call notification to a main LCD monitor 22 or a sub LCD monitor 24, and outputs an incoming call tone from a speaker for incoming call notification not shown. When a call-in operation is performed by the key input device 30, a telephone communication allowable state is established.

In the telephone communication allowable state, next processing is executed. A modulated audio signal (high frequency signal) transmitted from the intended party is received by the antenna 12. The received modulated audio signal is subjected to demodulation processing and decode processing by the transmitter/receiver 14. A received voice signal thus obtained is output from a speaker 18.

A voice transmission signal captured by a microphone 16 is subjected to encode processing and modulation processing by the transmitter/receiver 14. A modulated audio signal thus generated is transmitted to the intended party by means of the antenna 12 as described above.

A Felica circuit 28 is a short distance radio communication circuit constructed by a contactless IC card technology called “FeliCa” (registered trademark), and is provided with an antenna 28a. By holding the antenna 28a over the reading terminal (not shown) in a state that a Felica mode is selected by the key input device 30, data communication such as payment of a charge, etc. is performed.

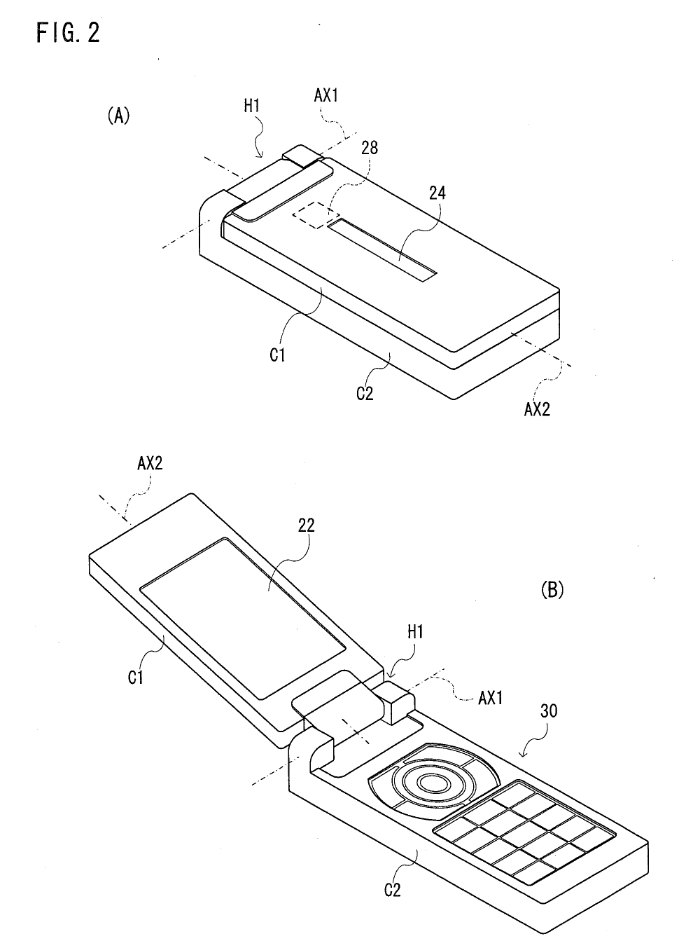

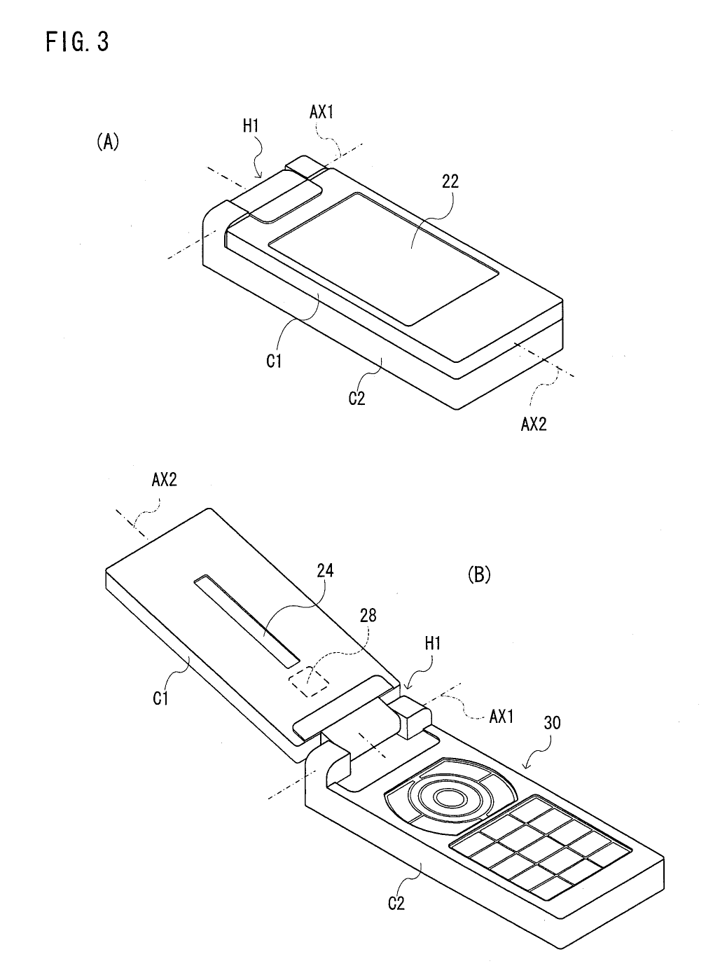

Referring to FIG. 2(A)-FIG. 2(B) and FIG. 3(A)-FIG. 3(B), the mobile communication terminal 10 has cases C1 and C2 each of which takes shape of a plate. The thicknesses of the cases C1 and C2 are approximately the same. The main LCD monitor 22 is provided to the case C1 so as to be exposed from an inner surface of the case C1, and the sub LCD monitor 24 is provided to the case C1 so as to be exposed from an outer surface of the case C1. The Felica circuit 28 is provided to the case C1 such that a fine receiving sensitivity thereof can be retained at the outer surface of the case C1. The key input device 30 is provided to the case C2 such that a group of operation keys are exposed from an inner surface of the case C2.

That is, the main LCD monitor 22 is provided to the inner surface of the case C1, the sub LCD monitor 24 and the Felica circuit 28 are provided to the outer surface of the case C1, and the key input device 30 is provided to the inner surface of the case C2.

At one end in a lengthwise direction of the inner surface of the case C2, a hinge mechanism H1 of a rotating two-axis hinge type is formed. The case C1 is connected with the hinge mechanism H1 on the side surface of the end in the lengthwise direction, rotates about an axis AX1 extending in parallel with a short side of the inner surface of the case C2, and rotates about an axis AX2 which is orthogonal to the axis AX1 and is in parallel with the inner surface of the case C1. The case C1 can have a position with respect to the case C2 as shown in FIG. 2(A), FIG. 2(B), FIG. 3(A) or FIG. 3(B).

As described above, the Felica circuit 28 is provided to the case C1 such that a fine receiving sensitivity can be obtained on the outer surface of the case C1. Thus, a data communication utilizing the Felica circuit 28 is executed by holding the outer surface of the case C1 over a reading terminal. In other words, even if the inner surface of the case C1 is held over the reading terminal, a data communication with the reading terminal is not executed. This means that in the position shown in FIG. 2(A), FIG. 2(B) or FIG. 3(B), a data communication with the reading terminal is possible while in the position shown in FIG. 3(A), a data communication with the reading terminal is impossible.

Hence, in this embodiment, whether or not a data communication by utilizing the Felica circuit 28 is possible is determined on the basis of the position of the case C1 with respect to the case C2, and a different notification depending on the determination result is output from an LCD monitor in an active state out of the main LCD monitor 22 and the sub LCD monitor 24.

More specifically, at the position shown in FIG. 2(A), a notification that “Felica can currently be used” is output from the sub LCD monitor 24, and at the position shown in FIG. 2(B), a notification that “Felica can currently be used” is output from the main LCD monitor 22. Furthermore, at the position shown in FIG. 3(A), a notification that “Felica cannot currently be used” is output from the main LCD monitor 22, and at the position shown in FIG. 3(B), a notification that “Felica can currently be used” is output from the sub LCD monitor 24.

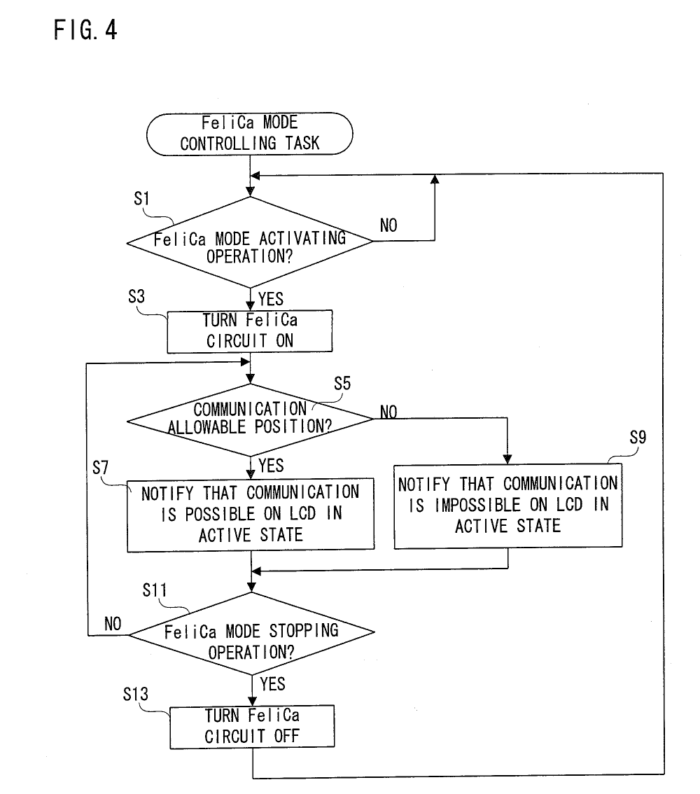

The CPU 26 executes a plurality of tasks including a Felica mode controlling task shown in FIG. 4 in parallel. Additionally, a control program corresponding to these tasks is stored in the flash memory 20.

In a step S1, it is determined whether or not a Felica mode activating operation is performed through the key input device 30. If “YES” here, the process proceeds to a step S3 to turn the Felica circuit 28 on. In a step S5, it is determined whether or not a relative position between the cases C1 and C2 is a communication allowable position. The determination result indicates “YES” in correspondence to the position shown in FIG. 2(A), FIG. 2(B) or FIG. 3(B), and indicates “NO” in correspondence to the position shown in FIG. 3(A).

If “YES” in the step S5, the process proceeds to a step S7 to inform that a communication by the antenna 28a is in a good condition (receiving sensitivity of the antenna 28a is in a good condition) through the LCD monitor in an active state. If “NO” is determined in the step S5, the process proceeds to a step S9 to inform that a communication by the antenna 28a is in a bad condition (receiving sensitivity of the antenna 28a is bad) through the LCD monitor in an active state. After completion of the step S7 or S9, it is determined whether or not a Felica mode stopping operation is performed through the key input device 30 in a step S11. If “NO” is determined here, the process returns to the step S5 while if “YES”, the Felica circuit 28 is turned off in a step S13, and the process returns to the step S1.

As understood from the above description, each of the case C1 (first case) and case C2 (second case) takes shape of a plate. The hinge mechanism H1 (connector) connects the case C1 and the case C2 such that the position of the case C1 with respect to the case C2 is changeable. The antenna 28a is provided to the outer surface (one main surface) of the case C1. The main LCD monitor 22 (first display) is provided to the inner surface (the other main surface) of the case C1 so as to be exposed at a specific position where the outer surface of the case C1 is covered with the inner surface (one main surface) of the case C2. The CPU 26 outputs from the main LCD monitor 22 a notification that a communication by the antenna 28a is in a bad condition in correspondence to the specific position (S9).

Since the antenna 28a is provided to the outer surface of the case C1, a receiving sensitivity of the antenna 28a at the specific position where the outer surface of the case C1 is covered with the inner surface of the case C2 is decreased. On the other hand, the main LCD monitor 22 is provided to the inner surface of the case C1 so as to be exposed at the specific position. Hence, in this embodiment, a notification that a communication by the antenna 28a is in a bad condition is output from the main LCD monitor 22 in correspondence with the specific position. Thus, it is possible to improve operability.

Additionally, in this embodiment, the main LCD monitor 22 is provided to the inner surface of the case C1, but the main LCD monitor 22 may be provided to the outer surface of the case C2. Furthermore, in this embodiment, the Felica circuit 28 is turned on in response to a Felica mode activating operation, but the Felica circuit is normally in an on state, and the condition, good or bad, of a communication by the antenna 28a may be notified by an icon.

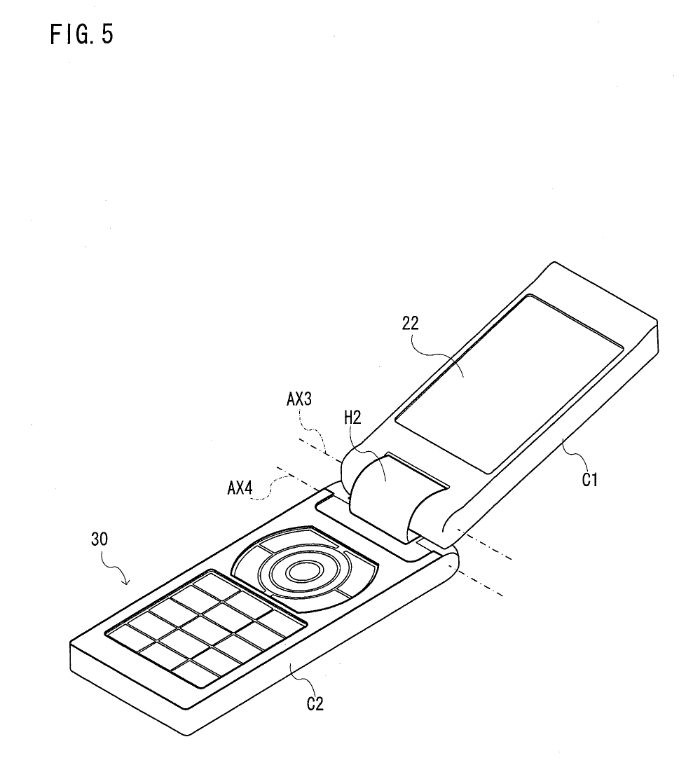

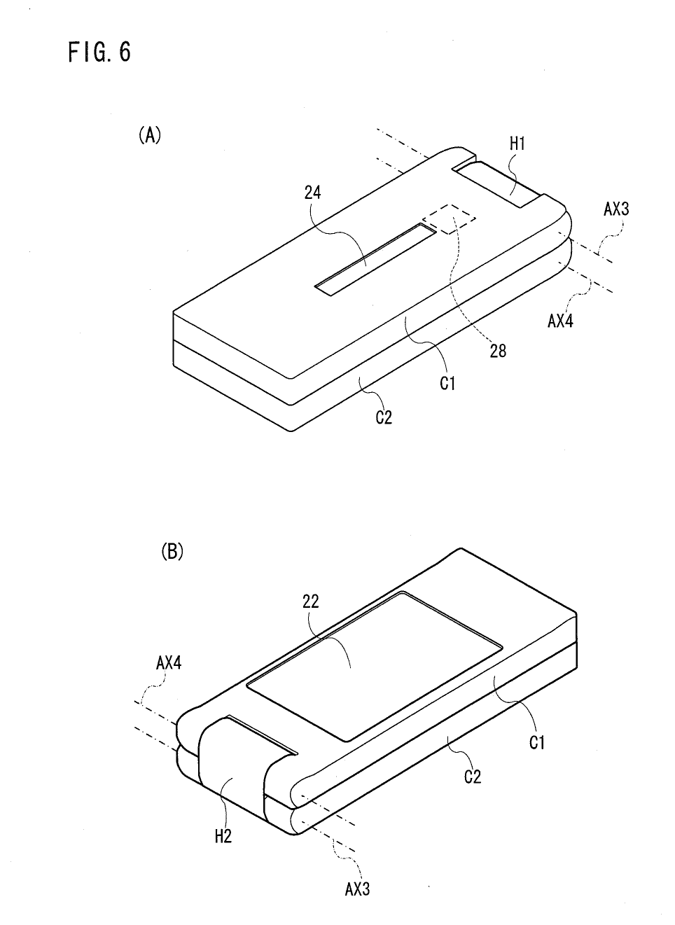

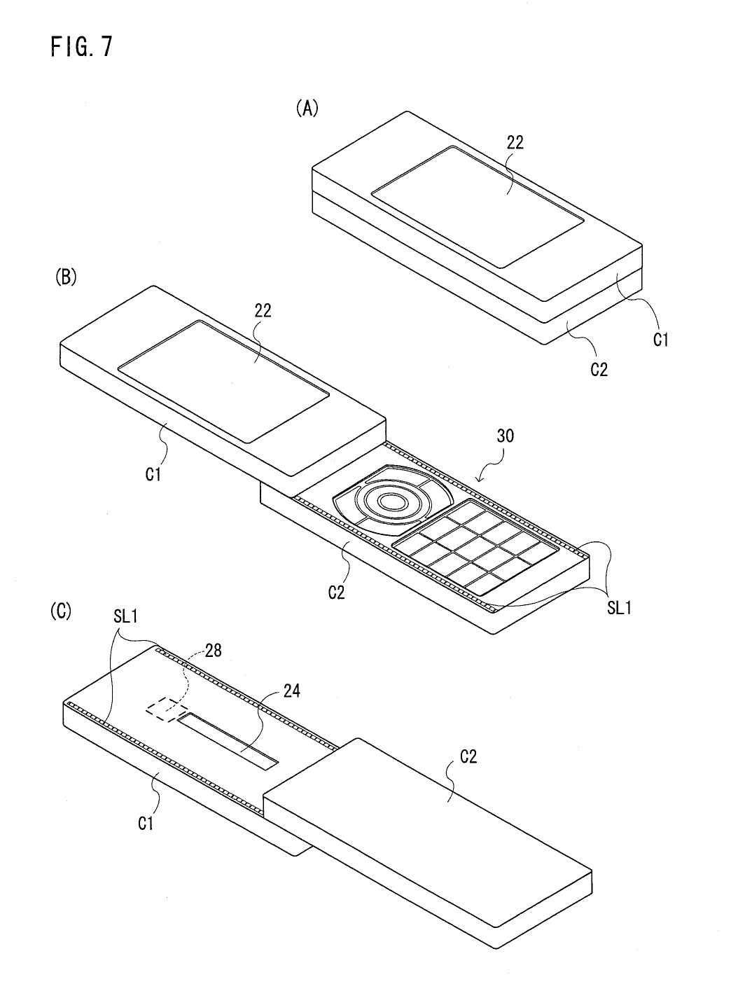

Furthermore, in this embodiment, the hinge mechanism H1 having the axes AX1 and AX2 which are orthogonal to each other is adopted, but in place of this, a hinge mechanism H2 shown in FIG. 5, FIG. 6(A) and FIG. 6(B), or a sliding mechanism SL1 shown in FIG. 7(A)-FIG. 7(C) may be adopted.

In the hinge mechanism H2 shown in FIG. 5, FIG. 6(A) and FIG. 6(B), an axis AX3 extends in parallel with a short side defining a main surface of a case C1, and an axis AX4 extends in parallel with a short side defining a main surface of a case C2. The axes AX3 and AX4 extend in parallel with each other by a distance corresponding to the thickness of the case C1 or C2 away. Thus, the angle of the main surface of the case C1 with respect to the main surface of the case C2 is variable at an angle from 0° to 360°. Additionally, a notification that a communication by the antenna 28a is in a bad condition is output from a main LCD monitor 22 in correspondence with a position shown in FIG. 6(B).

In the sliding mechanism SL1 shown in FIG. 7(A)-FIG. 7(C), a main LCD monitor 22 is provided to an upper surface of a case C1, a sub LCD monitor 24 and a Felica circuit 28 are provided on a lower surface of the case C1, and a key input device 30 is provided on an upper surface of a case C2. The sliding mechanism SL1 is provided at both ends in the width direction of the lower surface of the case C1 and at both ends in the width direction of the upper surface of the case C2. Thus, the case C1 can slide in the longitudinal direction of the case C2 in a state that it is stacked on the case C2. Additionally, a notification that a communication by the antenna 28a is in a bad condition is output from the main LCD monitor 22 in response to a position shown in FIG. 7(A).

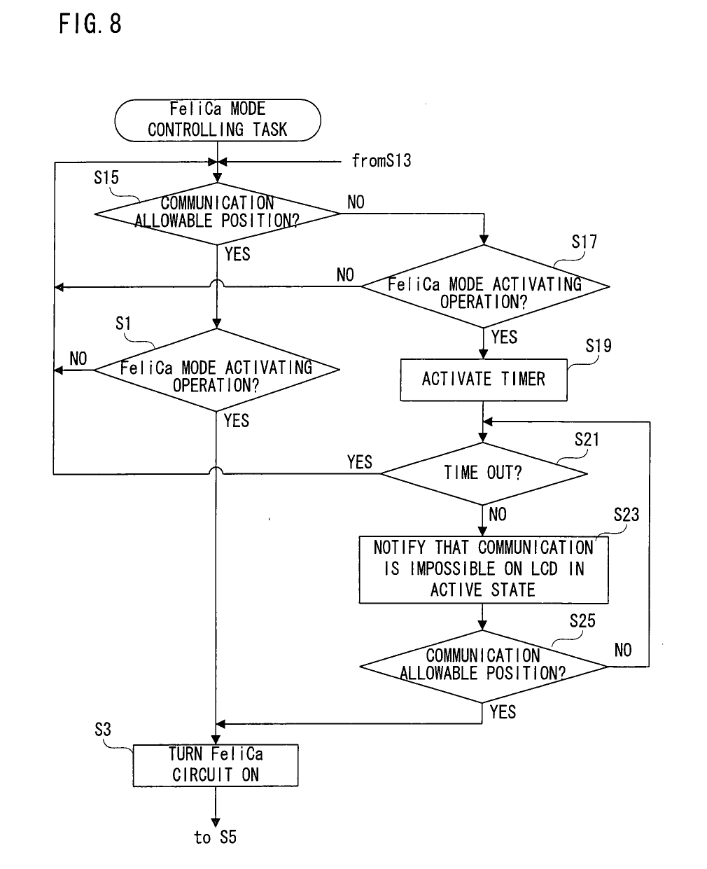

Furthermore, in the above-described embodiment, when a Felica mode activating operation is performed, the Felica circuit 28 is turned on irrespective of the relative position between the cases C1 and C2. However, the Felica circuit 28 may be turned on in response to a Felica mode activating operation in a state that the relative position between the cases C1 and C2 is a communication allowable position. In this case, processing may additionally be executed according to a flowchart shown in FIG. 8.

Referring to FIG. 8, in a step S15, it is determined whether or not the relative position between the cases C1 and C2 is in a communication allowable position. If “YES” here, the process proceeds to the step S1 while if “NO”, the process proceeds to a step S17. In the step S17, it is determined whether or not a Felica mode activating operation is performed, and if “YES”, a timer (not illustrated) is activated in a step S19. In a step S21, it is determined whether or not a time-out occurs (5 seconds elapse, for example). If “NO”, the process proceeds to a step S23 while if “YES”, the process returns to the step S15. In the step S23, that a communication by the antenna 28a is a bad condition (receiving sensitivity by the antenna 28a is bad) is notified to the LCD monitor in an active state. In a step S25, it is determined whether or not the relative position between the cases C1 and C2 is the communication allowable position. If “NO”, the process returns to the step S21 while if “YES”, the process proceeds to the step S3. It should be noted that the processing in the steps S19-S25 is processing for preventing continuous notification of impossibility of the communication when a Felica mode activating operation is accidentally performed from occurring.

It should be noted that although Felica is utilized in each of the embodiments, other short-distance radio methods such as MIFARE (registered trademark) may be utilized.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A communication terminal, comprising:
a first case and a second case;
a connector for connecting said first case and said second case such that a position of said first case with respect to said second case is changeable;
an antenna provided to one main surface of said first case;
a first display provided so as to be exposed at a specific position where the one main surface of said first case is covered with one main surface of said second case, at the other main surface of said first case or the other main surface of said second case; and
a first outputter for outputting a first notification that a communication by said antenna is in a bad condition from said first display in correspondence with said specific position.

2. A communication terminal according to claim 1, further comprising:
a communicator for executing communication processing by utilizing said antenna; and
an activator for activating said communicator when a preset condition is satisfied.

3. A communication terminal according to claim 2, wherein
said preset condition includes an operation condition that a communication activating operation is accepted, and a position condition that a position of said first case with respect to said second case is said specific position.

4. A communication terminal according to claim 3, further comprising a second outputter for outputting said first notification from said first display over a preset period when only said operation condition out of said operation condition and said position condition is satisfied.

5. A communication terminal according to claim 2, further comprising
a determiner for repetitively determining whether or not a position of said first case with respect to said second case is said specific position in association with the activating processing of said activator, wherein
said first outputter executes output processing when the determination result by said determiner is updated from a negative result to an affirmative result.

6. A communication terminal according to claim 1, wherein
said first display is provided to the other main surface of said first case.

7. A communication terminal according to claim 1, further comprising:
a second displaying apparatus provided to the one main surface of said first case and complementary shifted to an active state between said first display; and
a third outputter for outputting a second notification that a communication by said antenna is in a good condition to said display in the active state in correspondence with a position different from said specific position.

8. A communication terminal according to claim 1, wherein
said connector includes a hinge mechanism for rotating said first case about each of two axes which are orthogonal to each other.

9. A communication terminal according to claim 1, wherein
said connector includes a hinge mechanism for rotating said first case about each of two axes both of which are parallel with each other.

10. A communication terminal according to claim 1, wherein
said connector includes a sliding mechanism for sliding said first case while said first case is stacked on said second case.
